(19) United States
(12) Patent Application Publication
(10) Pub. No.: US 2017/0165820 A1
(43) Pub. Date: Jun. 15, 2017

(54) Oil filter Sock

(71) Applicant: David J. Leo, Duncan, SC (US)

(72) Inventor: David J. Leo, Duncan, SC (US)

(21) Appl. No.: 15/369,019

(22) Filed: Dec. 5, 2016

Related U.S. Application Data
(60) Provisional application No. 62/267,501, filed on Dec. 15, 2015.

(51) Int. Cl. B25B 27/00; B01D 35/00

(52) U.S. Cl. CPC B25B 27/0042; B01D 35/005; B01D 2201/24

(57) ABSTRACT

The present invention provides an oil filter sleeve. The oil filter sleeve provides a clean and safe method of removing an oil filter from the underside of a vehicle. The oil filter sleeve comprises a hollow cylindrical sleeve that removably attaches over an oil filter installed on a vehicle. The sleeve has an accordion like construction adapted to extend and retract in accordance with the size of the oil filter. Once the sleeve encloses the oil filter, a user may remove the oil filter from the vehicle and the oil filter sleeve will catch and hold any excess oil that leaves the oil filter. In this way, the oil filter sleeve prevents oil leakage and spillage.

### BACKGROUND

The present invention relates to improvements in oil filter sleeves. Changing an oil filter can be a very messy process. When a person removes an oil filter, excess oil may flow out of the filter and onto the hands of the person. This can make it very difficult for people to grasp the filter or parts of the car because they have oil on their hands. Furthermore, oil that spills on the ground can pose an environmental risk. Therefore, there exists the need for a device that can stop oil from leaking out of an oil filter as it is changed.

Devices in the prior art were found relating to oil filter sleeves. A device was found relating to oil filter sleeve comprising a disposable plastic bag adapted to be fitted around an oil filter that extends downwardly into the bag and thus allowing a mechanic to unscrew the oil filter without excessive oil spillage. Another device was found relating to oil filter sleeves comprising a canister-type oil filter in the form of an annular elastomeric sleeve having an upper end and a lower end. These devices, however, fail to include a cylindrical oil filter sleeve with an accordion construction allowing the device to extend and retract.

### BRIEF DESCRIPTION OF FIGURES

FIG. 1 shows a front perspective view of the oil filter sleeve in the removal stage of operation.

FIG. 2 shows a front perspective view of the accordion construction of the oil filter sleeve.

FIG. 3 shows a front perspective view of the oil filter sleeve in its initial stage of installation operation.

FIG. 4 shows a front perspective view of the oil filter sleeve being removed from the underside of a vehicle.

FIG. 5 shows a perspective view of oil filter sleeve in multiple embodiments.

### DESCRIPTION OF INVENTION

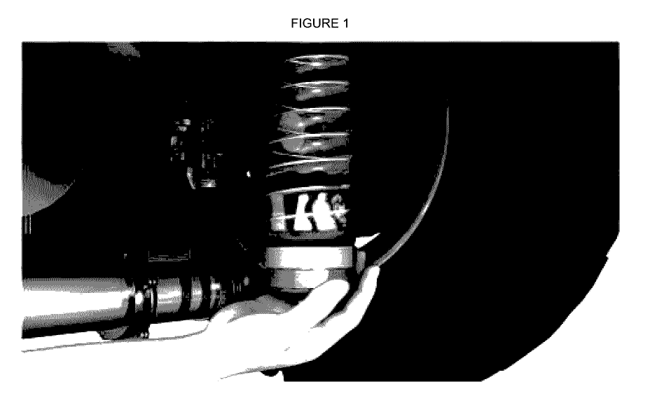

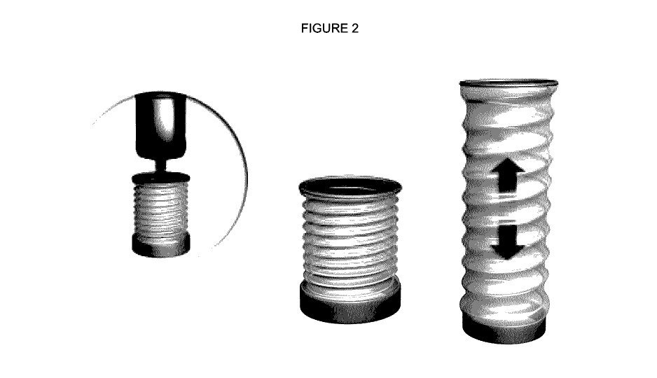

Referring now to FIGS. 1 and 2, there is a shown front perspective view of the oil filter sleeve in the removal stage of operation and a shown front perspective view of the accordion construction of the oil filter sleeve. The oil filter sleeve comprises a hollow tube having an open first end and a second end, wherein the first end is adapted to be placed substantially around an oil filter assembly installed on a vehicle. The oil filter sleeve includes an integral coil that allows for accordion-like expansion and retraction of the sleeve. Further, removable fasteners may be disposed toward the first and second end of the sleeve to secure the sleeve over the installed oil filter.

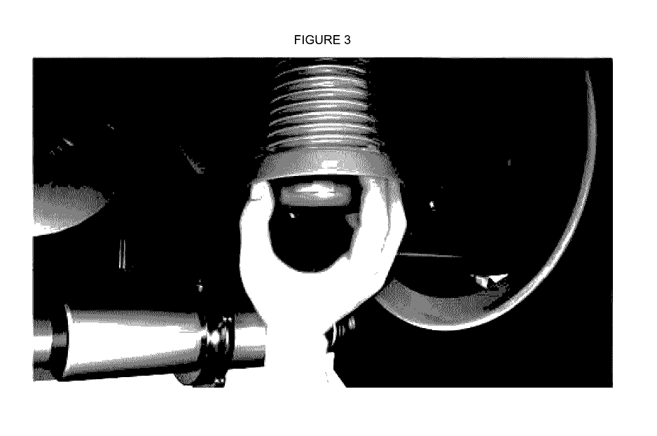

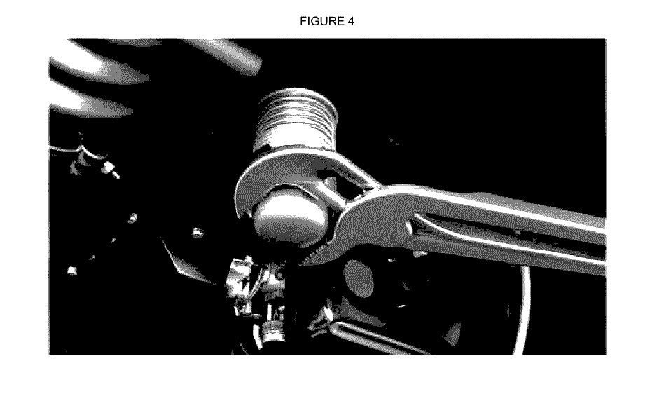

Referring now to FIGS. 3 and 4, there is a shown front perspective view of the oil filter sleeve in its initial stage of installation operation and a shown front perspective view of the oil filter sleeve being removed from the underside of a vehicle. The second end of the sleeve member includes a rubber ring disposed on the periphery of the sleeve adapted to secure the second end of the sleeve member to be substantially flush with the lower part of an oil filter. In this way, if oil leaks when the filter is removed, then the rubber ring will contain the oil within the sleeve and prevent spillage. Thus, the base of the oil filter may be easily handled because it remains clean and oil-free.

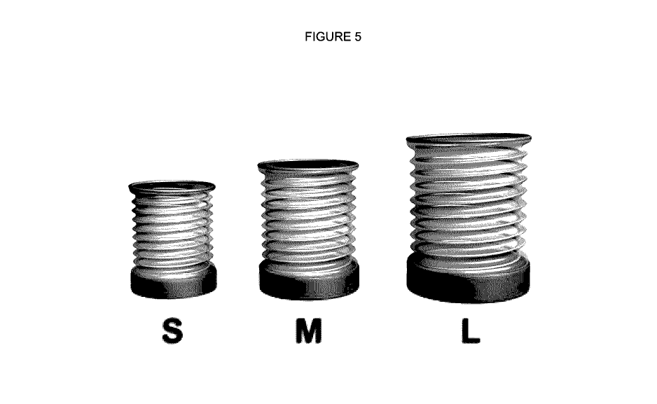

Referring now to FIG. 5, there are shown perspective views of the oil filter sleeve in multiple embodiments. In the shown embodiment, the oil filter sleeve can be semi-transparent. In this way, the user may see how much oil has spilled or leaked into the device. The oil filter sleeve may be constructed with plastic or a similar material. In the shown embodiment, the device may be constructed in various sizes configured to fit onto larger or smaller oil filters depending on the size of the vehicle.

In operation, the first end of the oil filter sleeve is placed over an installed oil filter until the first end is substantially flush with the underside of the vehicle. The user then manipulates the rubber ring on the second end to make it substantially flush with the lower part of the oil filter. Next, the user may remove the oil filter from the vehicle. As the oil filter is being removed, the oil filter sleeve prevents oil leakage and spillage that may occur when the oil filter is being removed, thus preventing oil from going on the ground or the hands of the user.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

1: An Oil Filter Sock Compromising of a cylindrical compression spring that is slightly larger than the diameter of an oil filter.

2: Placing a cylindrical vinyl/plastic tube covering, that is slightly larger in diameter than the compression spring, around the outer side of the compression spring.

3: Sealing the top outer part of the compression ring and the vinyl/plastic tube covering together, so that the top of the outer covering will not separate and fall down from the top of the compression spring.

4: When claims 2 & 3 are completed, the vinyl/plastic covering around the compression spring will be secure with the upper part of the spring when placing it over the oil filter.

5: Attaching a wide, cylindrical rubber band that is slightly smaller in diameter in claims 1, to the bottom of the compression spring and the vinyl/plastic tube covering.

6: Sealing the upper edge of the wide cylindrical rubber band to the very bottom of the compression spring and vinyl/plastic tube covering, securing all three items.

7: The rubber band in claim 5 and claim 6 will now be making a seal around the lower part of the oil filter when installing the Oil Filter Sock around the oil filter.

8: The Oil Filter Sock is now making a seal around the lower part of the oil filter and now you can remove the oil filter without the residue oil spilling down the sides of the oil filter. The Oil Filter Sock traps this residue oil thus preventing any mess of oil spilling on the person removing the oil filter or on the ground, making this product Environmentally Safe.

9: After removing the oil filter, with the Oil Filter Sock in place, option is to discard filter and sock with correct disposal procedures, or to remove the Oil Filter Sock to reuse at a later time.
